(19) United States
(12) Patent Application Publication
(10) Pub. No.: US 2011/0153101 A1
(43) Pub. Date: Jun. 23, 2011

(54) HOUSEHOLD ENERGY MANAGEMENT SYSTEM AND METHOD FOR ONE OR MORE APPLIANCES

(75) Inventors: Gregory M. Thomas, Louisville, KY (US); John K. Besore, Louisville, KY (US); Daniel Ryan Capelle, Lousiville, KY (US); Omar Santana, Louisville, KY (US); Brice Alan Bowley, Louisville, KY (US)

(73) Assignee: General Electric Company

(21) Appl. No.: 12/644,812

(22) Filed: Dec. 22, 2009

(51) Int. Cl. G06F 1/32

(52) U.S. Cl. 700/291; 700/295

(57) ABSTRACT

A household energy management system and method for one or more appliances includes a controller for managing power consumption within a household. The controller is configured to receive and process a signal indicative of one or more energy parameters of an associated energy utility. The controller includes a user interface for receiving energy management input for at least one appliance of the one of more appliances from a user. The controller at least one of controls and operates the at least one appliance in one of a plurality of operating modes, including at least a normal operating mode and an energy savings mode, in response to the input received by the user via the user interface in conjunction with the received signal.

### BACKGROUND

The present disclosure relates to energy management, and more particularly to power consuming device control methods and electrical energy consumption systems.

Many utilities are currently experiencing a shortage of electric generating capacity due to increasing consumer demand for electricity. Currently utilities generally charge a flat rate, but with increasing cost of fuel prices and high energy usage at certain parts of the day, utilities have to buy more energy to supply customers during peak demand. Consequently, utilities are charging higher rates during peak demand. If peak demand can be lowered, then a potential huge cost savings can be achieved and the peak load that the utility has to accommodate is lessened. In order to reduce high peak power demand, many utilities have instituted time of use metering and rates which include higher rates for energy usage during on-peak times and lower rates for energy usage during off-peak times. As a result, consumers are provided with an incentive to use electricity at off-peak times rather than on-peak times.

Presently, to take advantage of the lower cost of electricity during off-peak times, a consumer typically manually operates the power consuming devices during the off-peak times. For example, during off-peak times the consumer can decrease the setpoint temperature of an HVAC system and during on-peak times the consumer can increase the setpoint temperature and/or turn the system off. This is undesirable because the consumer may not always be present in the home to operate the devices during off-peak hours. This is also undesirable because the consumer is required to manually track the current time to determine what hours are off-peak and on-peak.

One proposed third party solution is to provide a system where a controller “switches” the actual energy supply to the power consuming devices on and off. However, there is no active control beyond the mere on/off switching. There are also currently different methods used to determine when variable electricity-pricing schemes go into effect. One difficulty of this method is that different electrical companies use different methods of communicating periods of high electrical demand to their consumers. Other electrical utility companies simply have rate schedules for different times of day. Therefore, there is a need to provide an improved household energy management system that is responsive to both input received by the consumer and with the demands of the utility.

### BRIEF DESCRIPTION

According to one aspect, a household energy management system for one or more appliances comprises a controller for managing power consumption within a household. The controller is configured to receive and process a signal indicative of one or more energy parameters of an associated energy utility. The controller includes a user interface for receiving energy management input for at least one appliance of the one of more appliances from a user. The controller at least one of controls and operates the at least one appliance in one of a plurality of operating modes, including at least a normal operating mode and an energy savings mode, in response to the input received by the user via the user interface in conjunction with the received signal.

According to another aspect, a household energy management system for one or more appliances comprises a controller for managing power consumption of the one or more appliances within a household. A user interface is operatively connected to the controller for receiving energy management input from a user. The user input is at least one of a delay indication, a cease indication and an override indication. The controller at least one of controls and operates the one or more appliances in one of a plurality of operating modes, including at least a normal operating mode and an energy savings mode, in response to the input received by the user via the user interface in conjunction with a signal received from an associated energy utility. The signal has a first state indicative of a utility peak demand period and a second state indicative of a utility off-peak demand period. The controller is configured to communicate to the associated energy utility a current operating mode of the one or more appliances and the energy management input from the user.

According to yet another aspect, a household energy management system for one or more appliances comprises a home energy manager having a controller for managing power consumption of one or more appliances within a household. A user interface displays data relating to the one or more appliances and receives input commands from a user. A utility meter measures an amount of energy usage to a household from an associated energy utility. The utility meter communicates to the home energy manager one or more energy parameters of the associated energy utility. The user interface provides a message to the user prompting an operational mode for each of the one or more appliances in response to the communication from the utility meter. Each operational mode has one of an allowable maximum energy usage and an allowable maximum energy cost for the appliance. The home energy manager controls or operates the one or more appliances in response to the communications from the utility meter and the operational modes selected by the user.

### BRIEF DESCRIPTION OF THE DRAWINGS

FIG. 1 is a schematic illustration of a household energy management system according to the present disclosure.

FIG. 2 is an exemplary operational flow chart for the household energy management system of FIG. 1.

### DETAILED DESCRIPTION

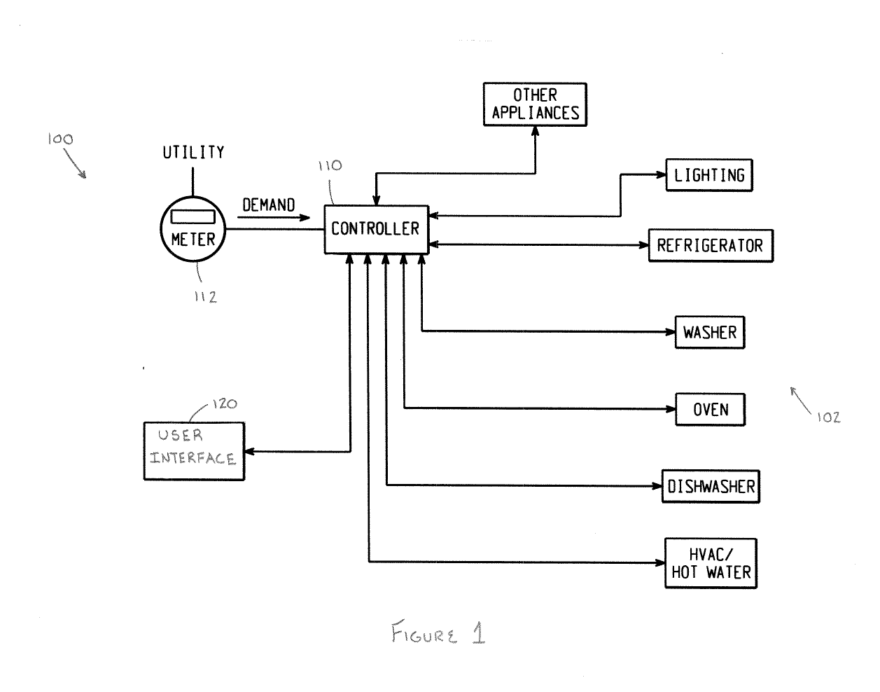

It should, of course, be understood that the description and drawings herein are merely illustrative and that various modifications and changes can be made in the structures disclosed without departing from the present disclosure. Referring now to the drawings, wherein like numerals refer to like parts throughout the several views, FIG. 1 schematically illustrates a household energy management system 100 for one or more appliances 102. The term “appliance” is used herein to include typical household appliances, for example a refrigerator, dishwasher, washer, dryer, microwave and oven, as well as an HVAC system, water heater and lighting. The energy management system comprises a controller 110, also referred to as a “home energy manager” (HEM), for managing power consumption of the one or more appliances within a household. The controller 110 can include a micro computer on a printed circuit board which is programmed to selectively control the energization of at least one power consuming feature/function of each appliance. The controller is in signal communication with an energy utility, such as an energy supplying utility or a third party utility aggregator. There are several ways to accomplish this communication, including but not limited to PLC (power line carrier, also known as power line communication), FM, AM SSB, WiFi, ZigBee, Radio Broadcast Data System, 802.11, 802.15.4, etc. The energy signal may be generated by the energy utility, such as a power company, and can be transmitted via a power line, as a radio frequency signal, or by any other means for transmitting a signal when the utility provider desires to reduce demand for its resources. Each appliance 102 has a communication interface that links itself to the controller 110.

The controller 110 is configured to receive and process a signal indicative of one or more energy parameters of an energy utility, for example, availability and/or current cost of supplied energy. Because some energy suppliers offer what is known as time-of-day pricing in their tariffs, price points could be tied directly to the tariff structure for the energy supplier. If real time pricing is offered by the energy supplier serving the site, this variance could be utilized to generate savings and reduce chain demand. Another load management program offered by energy supplier utilizes price tiers which the utility manages dynamically to reflect the total cost of energy delivery to its customers. The cost can be indicative of the state of the demand for the utility's energy, for example a relatively high price or cost of supplied energy is typically associated with a peak demand state or period and a relative low price or cost is typically associated with an off-peak demand state or period. As shown, a utility meter 112 is in signal communication with the controller 110 and provides the controller the parameters of the utility; although, this is not required.

The system 100 further includes a control panel or user interface 120, such as a display monitor or touch-screen, operatively connected to the controller 110. The user interface receives energy management input for each appliance 102 from the user. For example, according to one exemplary embodiment, the controller 110 includes a memory that stores past usage data, present usage data, and can also be programmed to store a selected response or mode of operation for each appliance depending on the data received from the energy utility. The user interacts with the controller through the user interface 120 to either receive messages and/or input data into the controller 110. By way of example only, the utility may provide data to the controller indicative of various operational costs. For example, “low”, “medium”, “high”, and “critical” cost structures may be provided to the controller. The user may program the controller 110 via the user interface 120 so that various home appliances respond or operate in a particular manner when one of the various pricing levels is indicated or in response to other data or conditions (i.e., not just cost). The controller 110 may prompt or suggest operational aspects for the user to consider in deciding whether to alter operation of each appliance. The user typically has the option to either accept the suggested mode of operation for each appliance, override the suggestion, or potentially modify to a different course of action. This information is then transmitted to the appliances from the controller 110, and once the appliances 102 begin to operate, a return signal or return data is provided to the controller from the appliances.

According to another exemplary embodiment, the controller 110 includes predefined operating modes or user profiles, such as a peak demand mode, an off-peak demand mode, an away mode and a vacation mode. Each predefined user profile is associated with a predetermined parameter of energy usage for each appliance, such as a maximum energy usage and/or a maximum energy cost for each appliance. Examples of predefined user profiles for several appliances are provided in the table below.

| Appli- | |
|---|---|
| ance | Predefined User Profile |
| HVAC | Normal Mode -- setpoint temperature per homeowner's settings |
| | Energy Savings Mode --- setpoint temperature shifted up/down |
| | by “x” degrees |
| Refrig- | Normal Mode -- setpoint temperature per homeowner's settings; |
| erator | all features working |
| | Energy Savings Mode --- setpoint temperature shifted up/down |
| | by “x” degrees; certain features delayed or disabled such as |
| | “quick chill” |
| Hot | Normal Mode -- setpoint temperature per homeowner's settings, |
| water | typically 130 F. |
| heater | Energy Savings Mode, Level 1 --- setpoint temperature shifted to |
| | 120 F. |
| | Energy Savings Mode, Level 2 --- setpoint temperature shifted to |
| | 100 F. |

It should be appreciated that the controller 110 can be configured with default settings which govern normal mode and energy savings mode operation. Such settings in each mode can be fixed while others adjustable to provide response to load shedding signals. In addition to the predefined user profiles, the controller 110 is configured to allow the user to create at least one unique user profile via the user interface 120. The unique user profile has a user selected parameter of energy usage for at least one appliance. In use, the user selects one of the predefined user profiles or the unique user profile via the user interface 120 for each appliance. The controller 110 at least one of controls and operates each appliance 102 in one of a plurality of operating modes, including at least a normal operating mode and an energy savings mode, in response to the input received by the user via the user interface in conjunction with the received signal. According to one exemplary embodiment, to reduce power consumption of each appliance in the energy savings mode, the controller 110 selectively adjusts and/or disables at least one power consuming feature/function of each appliance.

According to one aspect, the energy signal has an associated energy cost and the user input is a user selected targeted energy cost. The user input can be one of the predefined user profiles and/or a user created profile, each profile having an associated energy cost. Generally, each appliance is operated in the normal mode in response to a signal indicating an off-peak demand state or period and is operated in an energy savings mode in response to a signal indicating a peak demand state or period. If current energy cost exceeds the user selected cost (user profile energy cost), at least one appliance operates in the energy savings mode. If the current energy cost is less than the user selected cost (user profile energy cost), at least one appliance operates in the normal operating mode. This operation based on a user selected targeted energy cost is regardless of the current energy cost being indicative of one of a peak demand period and an off-peak demand period. According to another aspect, the energy signal has an associated energy cost and each of the predefined user profiles and the user created profile addresses varying energy cost preferences ranging from a conservative pricing preference to an aggressive pricing preference. For example, the aggressive pricing preference by a user will direct the system to trend towards maximum cost savings at the detriment of creature comfort or convenience. Conversely, a conservative pricing preference will trend the system towards optimizing creature comfort and convenience at the detriment of optimizing cost savings. It should be appreciated that there are varying degrees of control between these two exemplary pricing preferences. In this instance, each appliance operates in one of the plurality of operating modes based at least partially on the user selected energy cost preference.

The energy management input from the user can be an allowable maximum energy usage. The controller 110 handles energy management between the energy utility and appliances 102 with the user input incorporated in the decision making process. The energy savings mode of each appliance can be controlled or regulated based on priority and energy need level sent from the controller and/or the user. The controller 110 allocates energy to the appliances based on at least one of demand limit, a prioritization of each appliance, and an energy need level of each appliance. For example, the controller 110 is configured to assign to each appliance a unique identification character which allows the controller to segregate a demand response to each of the appliances. The energy usage of the power consuming features/functions of each appliance is balanced to prevent each appliance from exceeding the allowable maximum energy usage.

The user input can also be at least one of a delay indication, a cease indication and an override indication. The delay indication delays operation of at least one appliance or a power consuming function/feature thereof during the utility peak demand period until a signal indicative of a utility off-peak demand period is received. The cease indication disables at least one appliance or a specific power consuming feature/functions thereof upon receipt of a signal indicative of a utility peak demand period. The override indication at least partially overrides a signal indicative of a utility peak demand period to allow normal operation of at least one appliance or a power consuming feature/function thereof during the utility peak demand period. The override indication can provide the user the ability to select which of the one or more power consuming features/functions are delayed, adjusted and/or disabled by the controller in the energy savings mode. The user can override any adjustments, whether time related or function related, to any of the power consuming functions.

The determination of which power consuming features/functions are operated in a energy savings mode may depend on whether the appliance is currently operating. For example, for a refrigerator, the controller 110 may include functionality to determine whether activation of the energy savings mode for any power consuming features/functions would potentially cause damage to any feature/function of the refrigerator itself or would cause the refrigerator to fail to perform its intended function. If the controller 110 determines that an unacceptable consequence may occur by performing an energy saving action, such as deactivating or curtailing the operation of the refrigeration system, the controller may opt-out of performing that specific energy saving action or may institute or extend other procedures.

The controller 110 is configured to communicate to the energy utility at least one of a confirmation of receipt of the energy signal, the current operating mode of the at least one appliance, the energy management input from the user, current energy usage of the at least one appliance and actual load shed by the at least one appliance in response to the signal. Such information can be displayed on the user interface 120. The controller 110 is also configured to record and display at least one of day-to-day, month-to-month and year-to-year energy usage of each appliance and cost of operating each appliance in at least the energy savings mode and the normal mode.

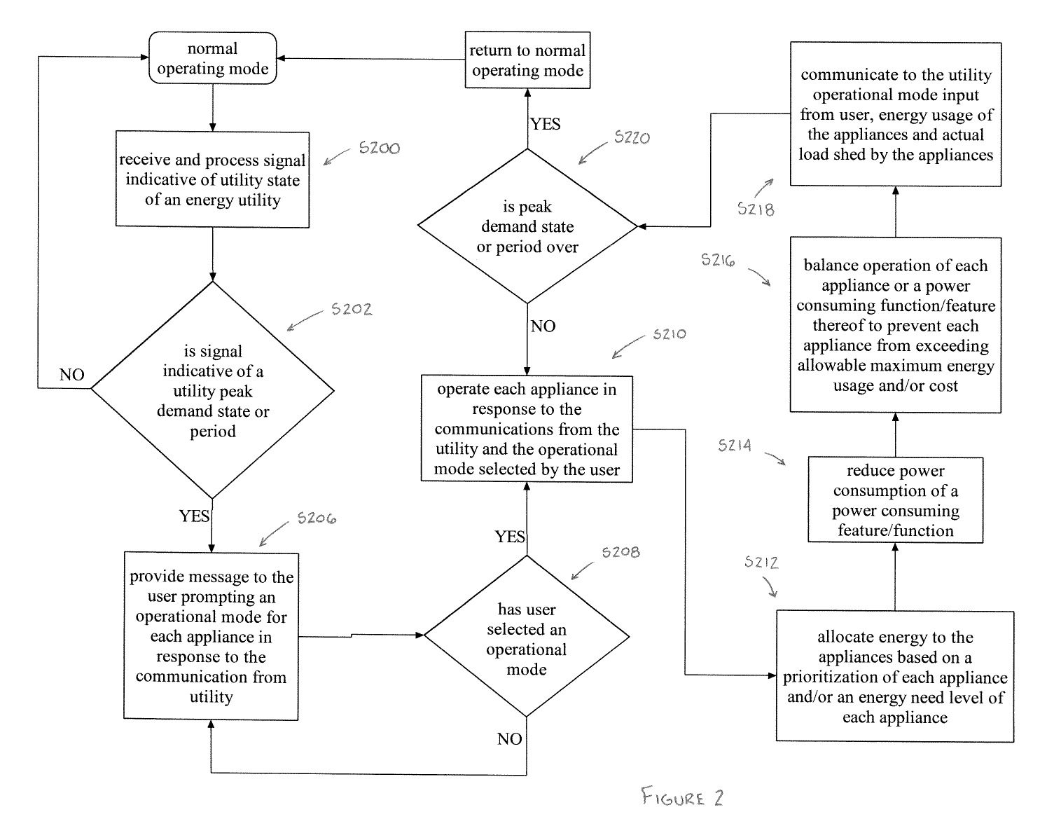

With reference to FIG. 2, an exemplary control method for the household energy management system 100 comprises receiving and processing the signal indicative of cost of the utility state of the utility (S200); determining whether the signal is indicative of a utility peak demand state or period (S202), the utility state being indicative of at least a peak demand period or an off-peak demand period; operating the appliance 200 in a normal mode during the off-peak demand period (S204); providing a message to the user prompting an operational mode for each of the appliances in response to the communication from the utility (S206); selecting an operational mode for each appliance, each operational mode can have one of an allowable maximum energy usage and an allowable maximum energy cost for each appliance (S208); operating each appliance in response to the communications from the utility and the operational modes selected by the user (S210); allocating energy to the appliances based on at least one of a prioritization of each of the appliances and an energy need level of each appliance (S212); scheduling, delaying, adjusting and/or selectively deactivating any number of one or more power consuming features/functions of each appliance to reduce power consumption of each appliance (S214); balancing operation of each appliance or a power consuming function/feature thereof to prevent each appliance from exceeding at least one of the allowable maximum energy usage and the allowable maximum energy cost (S216); communicating to the utility the operational mode input from the user, energy usage of the appliances and actual load shed by the appliances (S218); and returning to the normal mode after the peak demand state period is over (S220).

As indicated previously, the user interface 120 can include a display configured to provide active, real-time feedback to the user on the cost of operating each appliance. The costs associated with using each appliance are generally based on the current operating and usage patterns and energy consumption costs, such as the cost per kilowatt hour charged by the corresponding utility. The controller 110 is configured to gather information and data related to current usage patterns and as well as current power costs. This information can be used to determine current energy usage and cost associated with using each appliance in one of the energy savings mode and normal mode. This real-time information (i.e., current usage patterns, current power cost and current energy usage/cost) can be presented to the user via the display.

The duration of time that each appliance operates in the energy savings mode may be determined by information in the energy signal. For example, the energy signal may inform the controller 110 to operate in the energy savings mode for a few minutes or for one hour, at which time each appliance returns to normal operation. Alternatively, the energy signal may be continuously transmitted by the utility provider, or other signal generating system, as long as it is determined that instantaneous load reduction is necessary. Once transmission of the signal has ceased, each appliance returns to normal operating mode. In yet another embodiment, an energy signal may be transmitted to the controller 110 to signal each appliance to operate in the energy savings mode. A normal operation signal may then be later transmitted to the controller 110 to signal each appliance to return to the normal operating mode.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A household energy management system for one or more appliances, comprising:
a controller for managing power consumption within a household, the controller being configured to receive and process a signal indicative of one or more energy parameters of an associated energy utility, the controller including a user interface for receiving energy management input for at least one appliance of the one of more appliances from a user, wherein the controller at least one of controls and operates the at least one appliance in one of a plurality of operating modes, including at least a normal operating mode and an energy savings mode, in response to the input received by the user via the user interface in conjunction with the received signal.

2. The system of claim 1, wherein the energy signal has an associated energy cost and the user input is a user selected targeted energy cost, wherein if current energy cost exceeds the user selected cost, the at least one appliance operates in the energy savings mode, and wherein if the current energy cost is less than the user selected cost, the at least one appliance operates in the normal operating mode.

3. The system of claim 1, wherein the controller includes predefined user profiles, each user profile being associated with a predetermined parameter of energy usage for the at least one appliance, the user selecting one of the predefined user profiles via the user interface, the at least one appliance operating in one of the plurality of operating modes based at least partially on the predefined user profile.

4. The system of claim 3, wherein the controller is configured to allow a user to create a unique user profile via the user interface, the unique user profile having a user selected parameter of energy usage for the at least one appliance, the at least one appliance operating in one of the plurality of operating modes based at least partially on the user created profile.

5. The system of claim 4, wherein the energy signal has an associated energy cost and each of the predefined user profiles and the user created profile has an associated energy cost, wherein if current energy cost exceeds the user profile energy cost, the at least one appliance operates in the energy savings mode, and wherein if the current energy cost is less than the user profile energy cost, the at least one appliance operates in the normal operating mode.

6. The system of claim 4, wherein the energy signal has an associated energy cost and each of the predefined user profiles and the user created profile addresses varying energy cost preferences ranging from a conservative pricing preference to an aggressive pricing preference, the at least one appliance operating in one of the plurality of operating mode based at least partially on the user selected energy cost preference.

7. The system of claim 1, wherein the energy signal has an associated energy cost and the controller includes a display indicative of at least one of current cost of energy, current cost of operating the at least one appliance and actual load being shed by the at least one appliance.

8. The system of claim 1, wherein the controller is configured to record and display at least one of day-to-day, month-to-month and year-to-year energy usage of the at least one appliance and cost of operating the at least one appliance in at least the energy savings mode and the normal mode.

9. The system of claim 1, wherein the controller is configured to communicate to the associated energy utility at least one of a confirmation of receipt of the energy signal, the current operating mode of the at least one appliance, the energy management input from the user, current energy usage of the at least one appliance and actual load shed by the at least one appliance in response to the signal.

10. The system of claim 1, wherein the energy management input from the user is an allowable maximum energy usage, the controller being configured to balance the energy usage of power consuming features/functions of the at least one appliance to prevent the at least one appliance from exceeding the allowable maximum energy usage.

11. The system of claim 10, wherein the controller allocates energy to the one or more appliances based on at least one of demand limit, a prioritization of each of the one or more appliances, and an energy need level of each of the one or more appliances.

12. The system of claim 1, wherein the energy management input from the user is an allowable maximum energy cost, the controller being configured to balance the energy usage of power consuming features/functions of the at least one appliance to prevent the at least one appliance from exceeding the allowable maximum energy cost.

13. The system of claim 1, wherein the controller includes predefined operating modes, each predefined operating mode having a maximum energy usage for the at least one appliance, the user selecting one of the predefined operating modes via the user interface.

14. The system of claim 1, wherein the predefined operating modes includes an away mode and a vacation mode.

15. A household energy management system for one or more appliances, comprising:
a controller for managing power consumption of the one or more appliances within a household; and
a user interface operatively connected to the controller for receiving energy management input from a user, the user input being at least one of a delay indication, a cease indication and an override indication;
wherein the controller at least one of controls and operates the one or more appliances in one of a plurality of operating modes, including at least a normal operating mode and an energy savings mode, in response to the input received by the user via the user interface in conjunction with a signal received from an associated energy utility, the signal having a first state indicative of a utility peak demand period and a second state indicative of a utility off-peak demand period,
wherein the controller is configured to communicate to the associated energy utility a current operating mode of the one or more appliances and the energy management input from the user.

16. The system of claim 15, wherein the controller is configured to communicate to the associated energy utility energy usage of the one or more appliances and actual load shed by the one or more appliances.

17. The system of claim 15, wherein the delay indication delays operation of at least one appliance or a power consuming function/feature thereof during the utility peak demand period until a signal having the second state is received, the cease indication disables at least one appliance or a specific power consuming feature/function thereof upon receipt of a signal having the first state, and the override indication at least partially overrides a signal having the first state to allow operation of at least one appliance or a power consuming feature/function thereof during the utility peak demand period.

18. The system of claim 17, wherein the energy management input from the user is one of an allowable maximum energy usage and an allowable maximum energy cost, the controller being configured to balance operation of at least one appliance or a power consuming function/feature thereof to prevent the at least one appliance from exceeding one of the allowable maximum energy usage and the allowable maximum energy cost.

19. A household energy management system for one or more appliances, comprising:
a home energy manager having a controller for managing power consumption of one or more appliances within a household, and a user interface for displaying data relating to the one or more appliances and receiving input commands from a user; and
a utility meter for measuring an amount of energy usage to a household from an associated energy utility, the utility meter communicating to the home energy manager one or more energy parameters of the associated energy utility;
wherein the user interface provides a message to the user prompting an operational mode for each of the one or more appliances in response to the communication from the utility meter, each operational mode having one of an allowable maximum energy usage and an allowable maximum energy cost for the appliance, the home energy manager controls or operates the one or more appliances in response to the communications from the utility meter and the operational modes selected by the user.

20. The system of claim 19, wherein the home energy manager allocates energy to the one or more appliances based on at least one of a prioritization of each of the one or more appliances and an energy need level of each of the one or more appliances.

21. The system of claim 20, wherein the home energy manager is configured to assign to each appliance of the one or more appliances a unique identification character which allows the controller to segregate a demand response to the one or more appliances.
